(19) United States
(12) Patent Application Publication
(10) Pub. No.: US 2006/0027143 A1
(43) Pub. Date: Feb. 9, 2006

(54) Inorganic pigments using colored glass or its ingredients as base material and methods of making and using same

(76) Inventor: Shimon Brand, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/185,456

(22) Filed: Jul. 20, 2005

Related U.S. Application Data
(60) Provisional application No. 60/589,233, filed on Jul. 20, 2004.
(60) Provisional application No. 60/613,279, filed on Sep. 27, 2004.

(51) Int. Cl. C04B 14/00

(52) U.S. Cl. 106/479

(57) ABSTRACT

Pigments, made from pulverized Smalti or specifically formulated, highly-pigmented glass, suitable for coloring a variety of construction, industrial and other matrices are described, as well as methods for producing and using the pigments. For example, the pigments may be used to color concrete, plaster, grout, shotcrete, stucco, as well as a variety of other industrial paints and coatings produced using a water, alcohol, oil, resin, or petroleum-based solvent. In a preferred embodiment, the pigment particle size is sufficiently small to be suspended in the solvent. The pigments provide a variety of desirable characteristics including: availability of a wide range of brilliant hues, colorfastness over long periods of time in the presence of ultra-violet radiation, humidity, oxygen, and varying temperatures, imperviousness to harsh conditions and a wide range of acid/base variations.

### PRIORITY CLAIM

This application claims the benefit of priority under 35 U.S.C. § 119(e) of U.S. Provisional Application No. 60/589,233, filed on Jul. 20, 2004 and entitled INORGANIC PIGMENTS USING COLORED GLASS AS BASE MATERIAL AND METHODS OF MAKING AND USING SAME and of U.S. Provisional Application No. 60/613,279, filed on Sep. 27, 2004 and entitled INORGANIC PIGMENTS USING COLORED GLASS OR ITS INGREDIENTS AS BASE MATERIAL AND METHODS OF MAKING AND USING SAME, the entireties of which are incorporated herein by reference.

### FIELD OF THE INVENTION

The present invention relates to inorganic pigments to be used in the coloration of various matrices such as cement, concrete, shotcrete, stucco, plaster, mortar, grout, paint, automotive coatings, industrial coatings, coil coatings, ink, plastic, rubber, paper, ceramics, and others, using Smalti and other colored glass or its ingredients as raw material.

### BACKGROUND OF THE INVENTION

Two main families of issues are commonly considered when evaluating pigments for use in the coloration of matrices for construction, industrial, and other types of purposes: aesthetics and durability. It is well known that the pigment component in any formulation for the coloration of a cement-based matrix, paint, or other construction or industrial matrix can either enhance or degrade the overall performance, longevity, and aesthetic value of a finished product that incorporates the colored matrix. The search for perfect pigments for the coloration of paint and other matrices, namely pigments that (a) provide a broad range of colors, (b) retain their color and intensity over time in a variety of environmental conditions, and (c) do not have a deleterious effect on the quality of the matrix, has been an ongoing endeavor for centuries and continues to this day.

Whereas organic pigments can be used readily in a pH neutral environment, their use becomes inadvisable in acidic or highly alkaline matrices. In highly alkaline cement and silicate-based matrices, organic pigments react with the ambient environment to produce compounds that degrade the desired color over time. When used in exterior applications, organic pigments further react with ultra-violet (UV) rays, resulting in reduced weather-fastness and longevity.

Currently available inorganic pigments for coloration of concrete-based and other construction matrices, which are made of various oxides, typically provide only a sparsity of colors in the ranges of reds, browns, and yellows, and are, in any event, still subject to fading.

Some inorganic pigments for providing blue coloration are available, but are currently very expensive and are still subject to fading.

Some attempts have been made to produce pigments made from a combination of organic and inorganic materials, but to date, these pigments, too, are extremely expensive.

With respect to color intensity, in many situations, the quantity of pigment that may be added to a matrix before adversely affecting the functional performance of the matrix may be strictly limited. For example, it is commonly accepted that not more than 4% by weight of the cement in a mixture should comprise any of the currently available pigments for concrete, because higher percentages of pigment may compromise the strength of the finished concrete. One effect of this limitation is that it is nearly impossible to produce brilliantly colored concrete for exterior uses.

Additional considerations come in to play for the coloration of high-performance coatings, where exterior durability is of primary importance, such as those produced for the automotive, industrial, and marine applications, exterior masonry, coil-coatings, and “super-durable” powder coatings. These and other exterior coatings may be subjected to high temperatures in the presence of UV radiation, humidity, and oxygen for long periods of time. These factors may combine with the use of unsuitable pigment to initiate binder degradation, even with the most stable resin systems, and may lead to problems such as visible aging, loss of gloss, poor color retention, embrittlement of the coating, chalking, and delamination. Currently, functional demands have frequently necessitated foregoing the use of desired colors in the name of performance.

Of course, the cost of the various pigment options are an important consideration, and the users typically weigh aesthetics versus costs, ease of use versus longevity, etc. To date, the availability of a large palette of brilliant, affordable, and functionally practical colors for use by the construction materials industry, has been nonexistent.

### SUMMARY OF THE INVENTION

The present invention addresses and alleviates the above-mentioned deficiencies associated with the prior art. Pigments, made from pulverized Smalti or specifically formulated, highly-pigmented glass, suitable for coloring a variety of construction, industrial and other matrices are described, as well as methods for producing and using the pigments. For example, the pigments may be used to color concrete, plaster, grout, shotcrete, stucco, as well as a variety of other industrial paints and coatings produced using a water, alcohol, oil, resin, or petroleum-based solvent. In a preferred embodiment, the pigment particle size is sufficiently small to be suspended in the solvent. The pigments provide a variety of desirable characteristics including: availability of a wide range of brilliant hues, colorfastness over long periods of time in the presence of ultra-violet radiation, humidity, oxygen, and varying temperatures, imperviousness to harsh conditions and a wide range of acid/base variations

Embodiments of a pigment for coloring a material matrix are described wherein the pigment is produced from pulverized colored glass.

Embodiments of a method of producing pigment are described, wherein the method comprises milling glass granules to a particle size that is sufficiently small to suspend in drinkable water.

Embodiments of a material used in construction, wherein the material is colored with a pigment made of glass, wherein the material is at least one of: paint, concrete, plaster, grout, shotcrete, stucco, or a pre-cast concrete product.

Embodiments of a method for coloring concrete surfaces are described. The method comprises: broadcasting pulverized glass pigment upon setting concrete; tamping the glass pigment into the matrix; and trawling the surface of the concrete smooth.

Embodiments of a method of creating a thin surface of glass-pigment-colored concrete above a thicker uncolored concrete substrate are described, the method comprises: pouring a substrate of uncolored concrete of a thickness equaling a desired final thickness less the thickness of the top coating; and immediately thereafter, pouring concrete that is colored with glass pigment to the desired final height.

Neither this summary nor the following detailed description defines or limits the invention. The invention is defined by the claims.

### BRIEF DESCRIPTION OF THE DRAWING

FIG. 1 depicts an Impact Mill that may be used in producing one embodiment of the invention.

FIG. 2 depicts a Particle Classifier that may be used in producing one embodiment of the invention.

### DETAILED DESCRIPTION OF THE PREFERRED EMBODIMENT

The invention makes available a range of inorganic pigments providing a full palette of colors and hues, manufactured to meet the industry quest for chemical compatibility, longevity, acidic and alkaline imperviousness, UV opacity, weather-fastness and aesthetic contribution on a par with any paint color palette, while maintaining a cost factor easily borne by the industry.

Generally, the present invention comprises a palette of inorganic pigments and methods of producing and using the same. Embodiments of the invention use as raw material a vitreous substance formed by combining metals and/or metallic salts and oxides that provide a desired color, with silica and other materials typically used for the manufacture of glass. The materials are combined in the presence of a high degree of energy in the form of heat sufficient to produce glass, thereby creating a vitreous substance of highly-concentrated pigmentation that will be known, for purposes of this description, as “base glass.” The heat applied to the above-mentioned materials changes the properties of the materials to produce the desired colors and to bond the color and the glass components of the base glass.

One example of a base glass suitable for use in a variety of embodiments described herein is Smalti glass. The production of Smalti glass is an ancient and secretive art that was developed to provide a broad palette of colors for use in Byzantine-style mosaics. Smalti glass, manufactured by a limited number of sources around the world and available for sale to the public, uses a variety of metals and metallic salts and oxides to produce a virtually infinite range of colors and hues.

In other embodiments, other types of glass of similar color intensity may also be used as base glass. In some embodiments, the base glass is a vitreous material that is produced specially for use in manufacturing the pigments described herein.

The base glass is pulverized or otherwise reduced to particles of very small size, as will be described in greater detail below, such that the resultant particles provide color and UV opacity that is characteristic of metallic-based pigments, as well as reflective capabilities characteristic of glass.

The reflective capabilities of the base glass prevent the color of the pigment from fading over time as a result of exposure to ultraviolet rays. Similarly, when the base glass particles are used to color a matrix, the reflective qualities of the base glass particles protect organic components in the matrix from deterioration due to UV exposure.

As described above, usable pigment that provides the desired characteristics listed above may be formed from particles of Smalti or other commercially available or specially manufactured colored glass of highly-concentrated pigmentation. In various embodiments, the glass particles may be of different sizes as appropriate to the matrix and the application for which the pigment is being used. The ability to thoroughly mix into the matrix being colored and the effects of light reflection and refraction on the brilliance of the color imparted by the pigment may be taken into account in determining a desired particle size for use of the glass particles as pigment. Furthermore, in most embodiments, a desired particle size for coloration of a given matrix may be identified as a size that advantageously provides a greater coloration of the matrix with a lesser amount of pigment, thereby reducing costs, and transportation and storage resources associated with use of the pigment.

In general, for most embodiments in which the matrix to be colored is composed of one or more opaque materials, a desired particle size for the pigment approximates the size of a smallest matrix component particle. For example, when the pigment is used to color concrete, a desired pigment particle size approximates the size of a particle of cement in the matrix (approximately 0.1 micron) rather than the size of sand granules or other aggregate included in the concrete mix. In some embodiments, such as in some embodiments where the matrix to be colored is translucent, desired particle size for the pigment may be based on considerations other than the size of matrix particles.

Another test for identifying a desired particle size for use with a given matrix is to identify the size of particles that are sufficiently small to suspend in drinkable water or other solvent used in preparation of the desired matrix, thereby allowing for an even dispersion of the pigment throughout the matrix. Examples of other commonly used solvents include: oil, alcohol, resin, or other petroleum-based solvents. Such sufficiently small particles will change the color of the water or other solvent to that of the pigment. When water or other solvent so colored is introduced to an appropriate matrix, the pigment may be evenly dispersed and distributed throughout the matrix. For example, in this way, the pigment may be used to color concrete, paint, plaster, shotcrete, or grout. The pigment may also be used for non-cementious matrices such as resin-based matrices and the like.

In other embodiments, rather than first mixing the pigment in a solvent and then mixing the pigment-colored solvent into the matrix, the pigment may be mixed directly into the matrix. For example, when using the pigment to color concrete, the pigment may be mixed into the cement or concrete in powder form before adding the water that is customary in the production of concrete applications. In another embodiment, pigment may be broadcast or otherwise applied to a surface of a matrix, thus forming a thin top or outer layer of colored matrix. In yet another embodiment, pigment may be combined with a small portion of the matrix, and the colored matrix may be applied over uncolored matrix, in order to produce a colored surface. These and other methods for using pigment produced with metallic elements bonded in a glass matrix to color a wide variety of matrices and objects are contemplated as being within the scope of the invention as described herein.

Embodiments of a process by which base glass is converted into pigments suitable for use in the construction, paint, and other industries consist of a series of steps through which the base glass raw material is pulverized, such as by a Ball Mill, Impact Mill, Jet Mill, or other type of mill. In other embodiments, other methods of pulverizing base glass to a size usable as a pigment may also be used.

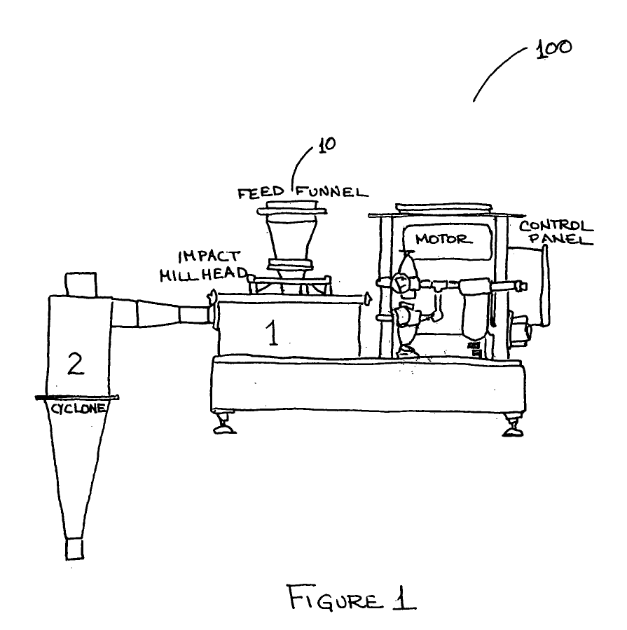

FIG. 1 depicts an Impact Mill 100 that may be used for producing the pigment from base glass. Base glass is introduced into the Impact Mill 100 through a feed funnel 10. From the feed funnel 10, the base glass is mechanically accelerated into stationary blocks inside a mill housing 1. The shattered base glass is air swept out of the mill housing 1 and into a cyclone 2. The cyclone 2 sends the shattered base glass material into a collection receptacle and glass dust created by the process is carried off to a dust collector.

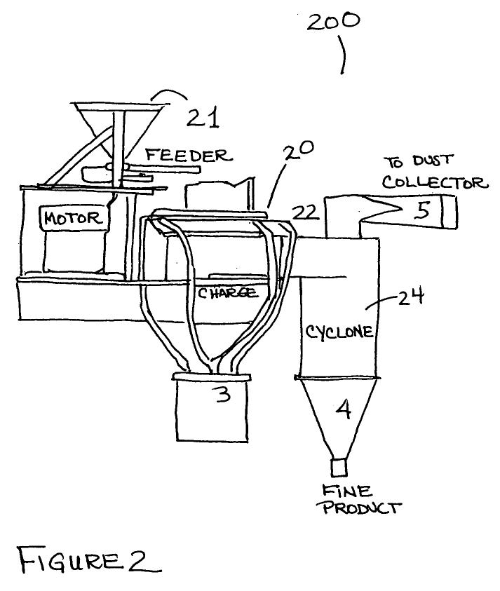

FIG. 2 depicts a particle classifier 200 that may be used in conjunction with the Impact Mill 100 in a next phase of a process for producing pigment from colored base glass. When the base glass has been ground such that a desired portion of the base glass has been ground to a particle size of approximately 0.1 micron, or other desired size, the ground base glass material is introduced into a feeder 21 of a particle classifier 200. The particle classifier 200 mechanically accelerates the unclassified base glass material and sends it through a classifier housing 20 into an opposing air flow 22. Ground material with of sufficient size and enough inertia to overcome the opposing airflow 22 is sent toward an outer periphery of the housing 20 and is then sent to a coarse product receptacle 3. Typically, the material in the coarse product receptacle 3 is considered of larger-than-desired particle size for use as pigment and may be fed again to the Impact Mill 100 for further grinding. Smaller-particled, ground base glass material, which is lighter, is swept away by the airflow 22 into the classifier housing 200, which contains screens of desired sizes, which separate the particles based on particle size, and on to the cyclone 24, where the fine product is sent into a fine product receptacle 4 where the finished product is stored. Base glass particles of a size smaller than desired may be carried off to a dust collector 5. The milling and classifying processes may be adjusted and repeated in order to produce uniformly-sized pigment particles of the desired size.

Ingredients used for making base glass may include silicon dioxide or other type of sand, soda ash, potash, sodium sulfate, calcium carbonate, and stabilizers such as oxides of calcium, aluminum, zinc, magnesium, or boron. Coloring agents for the base glass may include manganese, iron, nickel, and cobalt for brown and gray colors, and, in high concentrations, black. Intensive red, orange, and yellow colors may be produced by the precipitation of precious metal colloids, as well as those of selenium, cadmium sulfide, and cadmium selenide.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms. Accordingly, the accompanying claims and their equivalents are intended to cover such forms or modifications as would fall within the scope and spirit of the invention.

What is claimed is:

1. A pigment for coloring a material matrix wherein the pigment is produced from pulverized colored glass.

2. The pigment of claim 1, wherein the colored glass is Smalti glass.

3. The pigment of claim 1, wherein the matrix is an inorganic material.

4. The pigment of claim 3, wherein the matrix is a cement-based matrix.

5. The pigment of claim 1, wherein the matrix is an organic matrix.

6. The pigment of claim 1, wherein the matrix is paint.

7. The pigment of claim 1, wherein the matrix is at least one of: an automotive coating, an industrial coating, and a coil coating.

8. The pigment of claim 1, wherein the matrix is a powder coating.

9. The pigment of claim 1, wherein the pigment is used to color at least one of: plastic, rubber, paper, and ceramics.

10. The pigment of claim 1, wherein the colored glass is produced by combining, in the presence of heat sufficient for producing glass, metals and/or metallic salts with silica and other ingredients for making glass.

11. A method of producing pigment, the method comprising milling glass granules to a particle size, wherein the particles are sufficiently small to suspend in drinkable water.

12. The method of claim 11, wherein milling comprises milling the glass granules using at least one of: an Impact Mill, a Jet Mill, or a Ball Mill.

13. The method of claim 11, further comprising causing the milled particles to be processed through a classifier that separates over-sized particles from particles that will suspend in drinkable water

14. A method of coloring a cementious or resin-based matrix, the method comprising:
creating a suspension of pulverized glass pigment in solvent;
introducing the suspension to ingredients of a matrix; and
thoroughly mixing the suspension and the ingredients.

15. The method of claim 14, wherein the solvent is at least one of: water, alcohol, oil, resin, or a petroleum base.

16. A material used in construction, wherein the material is colored with a pigment made of glass.

17. The material of claim 16, wherein the material is at least one of: paint, concrete, plaster, grout, shotcrete, stucco, or a pre-cast concrete product.
